(19) United States
(12) Patent Application Publication
(10) Pub. No.: US 2012/0054035 A1
(43) Pub. Date: Mar. 1, 2012

(54) INTERNET TELEMATICS SERVICE PROVIDING SYSTEM AND METHOD FOR PROVIDING PERSONALIZED AND SOCIAL INFORMATION

(75) Inventors: Kyung Bo NAM, Seongnam-si (KR); Choong Hee LEE, Seongnam-si (KR)

(73) Assignee: NHN CORPORATION, Seongnam-si (KR)

(21) Appl. No.: 13/217,588

(22) Filed: Aug. 25, 2011

(30) Foreign Application Priority Data
Aug. 25, 2010 (KR) 10-2010-0082309

(51) Int. Cl. G06F 15/16; G06Q 30/00

(52) U.S. Cl. 705/14.58; 709/217

(57) ABSTRACT

An Internet telematics service providing system and method that may provide personalized point of interest (POI) information using various types of Web information are provided. The Internet telematics service providing system may include an interest information provider to provide interest information based on information that is found on the Internet and/or a telematics system associated with a user, a route receiver to receive a location of the user and/or a travel route from the telematics system, a POI extractor to extract POI information corresponding to the interest information based on the location of the user and/or the travel route, and a POI providing unit to provide the POI information to the telematics system.

### CROSS REFERENCE TO RELATED APPLICATION

This application claims priority from and the benefit of Korean Patent Application No. 10-2010-0082309, filed on Aug. 25, 2010, which is hereby incorporated by reference for all purposes as if fully set forth herein.

### BACKGROUND OF THE INVENTION

1. Field of the Invention

Exemplary embodiments of the present invention relate to an Internet telematics service providing system and method that may provide personalized point of interest (POI) information using various types of Web information.

2. Discussion of the Background

There have been active developments in telematics technology of providing various services, such as, for example, providing an automatic accident report, an emergency service call, and/or a guide service, to a driver through a terminal which may be installed in a vehicle of the driver by integrally employing a mobile communication technology, a satellite positioning technology, a map information technology, and/or a vehicle control technology. The telematics technology may provide a more convenient and safe driving environment and an environment in which the driver may use information services in the vehicle without interruption.

There is, however, a need for an enhanced system and method which may provide more information to a driver of a vehicle by using various Internet services.

### SUMMARY OF THE INVENTION

Exemplary embodiments of the present invention provide an Internet telematics service providing system and method that may provide point of interest (POI) information in which information associated with a user and/or a vehicle is reflected, based on Internet information, thereby enhancing the navigation quality and convenience.

Exemplary embodiments of the present invention also provide an Internet telematics service providing system and method that may process and provide personal and social Web-based information.

Additional features of the invention will be set forth in the description which follows, and in part will be apparent from the description, or may be learned by practice of the invention.

Exemplary embodiments of the present invention disclose a system to provide an Internet telematics service. The system includes a telematics system, an interest information provider, a route receiver, a point of interest (POI) information extractor, and a POI information providing unit. The interest information provider provides interest information based on information obtained from at least one of the Internet and the telematics system. The route receiver receives at least one of a location and a travel route from the telematics system. The POI information extractor extracts POI information corresponding to the interest information based on the at least one of the location and the travel route. The POI information providing unit provides the POI information to the telematics system.

Exemplary embodiments of the present invention also disclose a method of providing an Internet telematics service. The method includes providing interest information based on information obtained from at least one of the Internet and a telematics system, receiving at least one of a location and a travel route from the telematics system, extracting point of interest (POI) information corresponding to the interest information based on the at least one of the location and the travel route, and providing the POI information to the telematics system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram of a telematics system, a communication terminal, and an Internet telematics service providing system according to exemplary embodiments of the present invention.

FIG. 2 is a block diagram illustrating a configuration of an Internet telematics service providing system for providing point of interest (POI) information in which information the user may be interested in is reflected according to exemplary embodiments of the present invention.

FIG. 3 is a view of a point of interest (POI) information providing service according to exemplary embodiments of the present invention.

FIG. 4 is a block diagram illustrating an additional configuration of an Internet telematics service providing system for providing content associated with a location of a vehicle and/or a travel route according to exemplary embodiments of the present invention.

FIG. 5 is a block diagram illustrating an additional configuration of an Internet telematics service providing system for providing and sharing Internet content associated with POI information according to exemplary embodiments of the present invention.

FIG. 6 is a block diagram illustrating an additional configuration of an Internet telematics service providing system for providing advertising information associated with POI information according to exemplary embodiments of the present invention.

FIG. 7 is a flowchart illustrating an Internet telematics service providing method for providing personalized and social POI information according to exemplary embodiments of the present invention.

FIG. 8 is a flowchart illustrating an Internet telematics service providing method for providing and sharing Internet content associated with POI information according to exemplary embodiments of the present invention.

FIG. 9 is a flowchart illustrating an Internet telematics service providing method for providing advertising information associated with POI information according to exemplary embodiments of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Detailed descriptions of well-known functions and structures incorporated herein may be omitted to avoid obscuring the subject matter of the present invention.

The terminology used herein is for the purpose of describing exemplary embodiments only, and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It should be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the present invention will be described in detail with reference to the accompanying drawings.

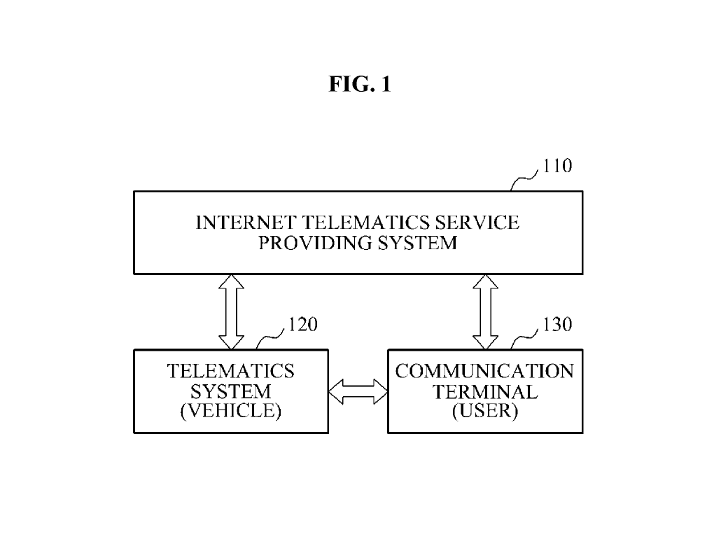

FIG. 1 is a block diagram of a telematics system 120, a communication terminal 130, and an Internet telematics service providing system 110 according to exemplary embodiments of the present invention. Referring to FIG. 1, the telematics system 120 of a vehicle and/or the communication terminal 130 used by a user may interact with the Internet telematics service providing system 110. In some cases, the user may be a driver of the vehicle.

The Internet telematics service providing system 110 may provide personalized and social information with respect to a current location of the vehicle or a travel route in interaction with the telematics system 120 and/or the communication terminal 130. The Internet telematics service providing system 110 may provide, to the telematics system 120, content (e.g., Internet content) associated with the current location or the travel route, as well as point of interest (POI) information, in which information the user may be interested in is reflected, with respect to the current location of the vehicle or the travel route. Also, the Internet telematics service providing system 110 may automatically store content associated with POI information in a webpage associated with the user, or may provide the content to the communication terminal 130 in real time.

The telematics system 120 may be, for example, a navigation terminal installed in the vehicle, and may communicate with the Internet telematics service providing system 110 and/or the communication terminal 130 over a wireless data network. In general, the telematics system 120 may be any electronic device that can communicate with the Internet telematics service providing system 110 and/or the communication terminal 130 in any suitable manner.

The communication terminal 130 may be any suitable mobile device including, for example, a portable personal computer (PC) or a mobile phone, and may communicate with the Internet telematics service providing system 110 and/or the telematics system 120 over any suitable wireless data network. Examples of suitable wireless data network include, but are not limited to, wireless wide area networks (WANs), wireless metropolitan area networks (WMANs), wireless mesh networks, Worldwide Interoperability for Microwave Access (WiMAX), cellular networks, and other broadband wireless microwave and radio frequency networks.

The telematics system 120 may be installed in the vehicle as a navigation terminal or may be provided as a separate apparatus, and may also be provided in a mobile communication terminal capable of providing a navigational service. In some cases, the telematics system 120 and the communication terminal 130 may be configured in the same apparatus.

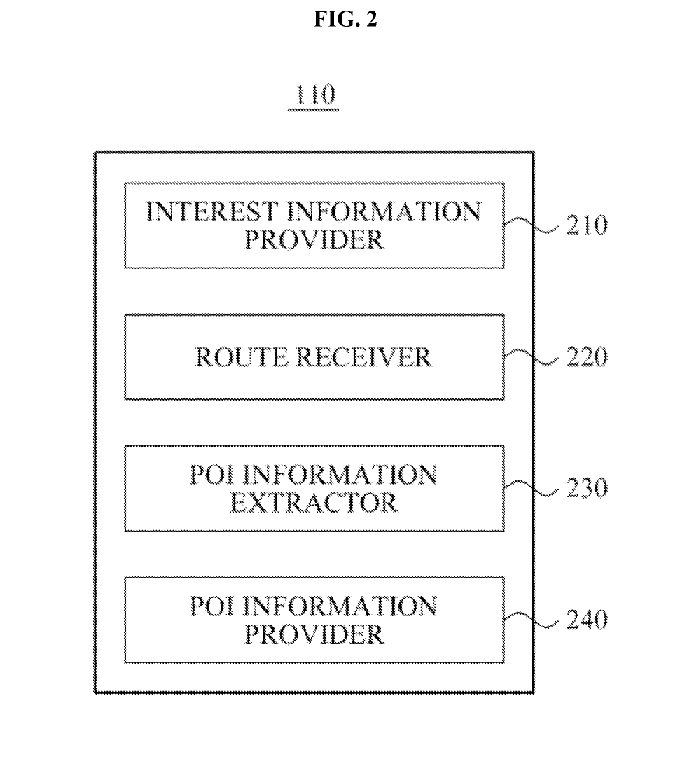

FIG. 2 is a block diagram illustrating a configuration of an Internet telematics service providing system 110 for providing POI information in which information the user may be interested in is reflected according to exemplary embodiments of the present invention. Referring to FIG. 2, the Internet telematics service providing system 110 may include an interest information provider 210, a route receiver 220, a POI information extractor 230, and a POI information providing unit 240.

The interest information provider 210 may provide information which may be of interest to the user (e.g., interest information) based on information available on the Internet and/or the telematics system 120. The interest information provider 210 may provide interest is information based on user information and/or user history that may be obtained from the Internet.

For example, interest information may be obtained using at least one of personal information of the user, for example, a hobby, an occupation, age, and/or sex of the user. This information may be obtained from information input when the user joins a membership on the Internet, a search history of a search engine, a characteristic of a website bookmarked by the user, and a characteristic of a website (e.g., blog, café) associated with the user. The interest information of a user may also include interest information of an operator of the website associated with the user, interest information of another user selected by the user, and/or content created by the other user. The other user may be selected by the user via an input mechanism of the telematics system 120 or the communication terminal 130. The website associated with the user may be a website or an online community the user has joined. For example, the website associated with the user may include a blog, an online café, and/or a website (e.g., social networking website) in which the user may have online friends, acquaintances, and/or neighbors.

Content created by a member of the website associated with the user or by an online friend of the user may also be used as basic data for providing interest information. When providing the interest information, information associated with the user, information of the website associated with the user, and/or information of another user selected by the user may also be used.

The interest information provider 210 may also provide interest information of the user based on a history in the telematics system 120 and/or a current location of the user. For example, the telematics system 120 may obtain the interest information of the user based, in part, on at least one telematics information among a POI list registered by the user, a search history of is a POI, a visit history corresponding to a POI, and/or a current location of the user. As an example, the interest information provider 210 may select information corresponding to a predetermined time period (e.g., a previous week or in general any user-specified time period) from user information and telematics information and may use the selected information as information to provide the interest information. As another example, the interest information provider 210 may extract a keyword from the user information and the telematics information and may determine a keyword of interest (i.e., interest keyword) based on an extraction frequency for each keyword and then provide the determined interest keyword as interest information. Also, the interest information provider 210 may provide the interest information by reflecting telematics information of another user selected by the user, in addition to telematics information of the user. Interest information of the user may also be obtained from a POI list registered by another user, a search history of the other user or of a POI, a visit history corresponding to a POI, and/or a current location of the other user.

The route receiver 220 may receive information regarding a location of the user's vehicle and/or a travel route of the user's vehicle from the telematics system 120 in real time. For example, the route receiver 220 may receive information regarding the user's vehicle's travel route to a destination that is set in the telematics system 120.

The POI information extractor 230 may extract POI information corresponding to the interest information of the user based on the location of the vehicle and/or the vehicle travel route from an Internet map server (not shown). For example, the POI information extractor 230 may extract POIs which are situated around the current location of the vehicle and/or the travel route and may then extract POI information corresponding to the interest information from the extracted POIs. The POI information extractor 230 may extract a POI list corresponding to the interest information, location information for each POI, and/or corresponding detail information such as a telephone number and/or an address of each POI.

The POI information providing unit 240 may provide POI information corresponding to the interest information to the telematics system 120. The POI information may be displayed on a map screen mapping the current location of the vehicle and/or the travel route using the telematics system 120.

According to the above configuration of FIG. 2, the Internet telematics service providing system 110 may provide information to the user using the telematics system 120 and personalized POI information in which interest information of the user is reflected based on the current location of the vehicle and/or the travel route to the user destination.

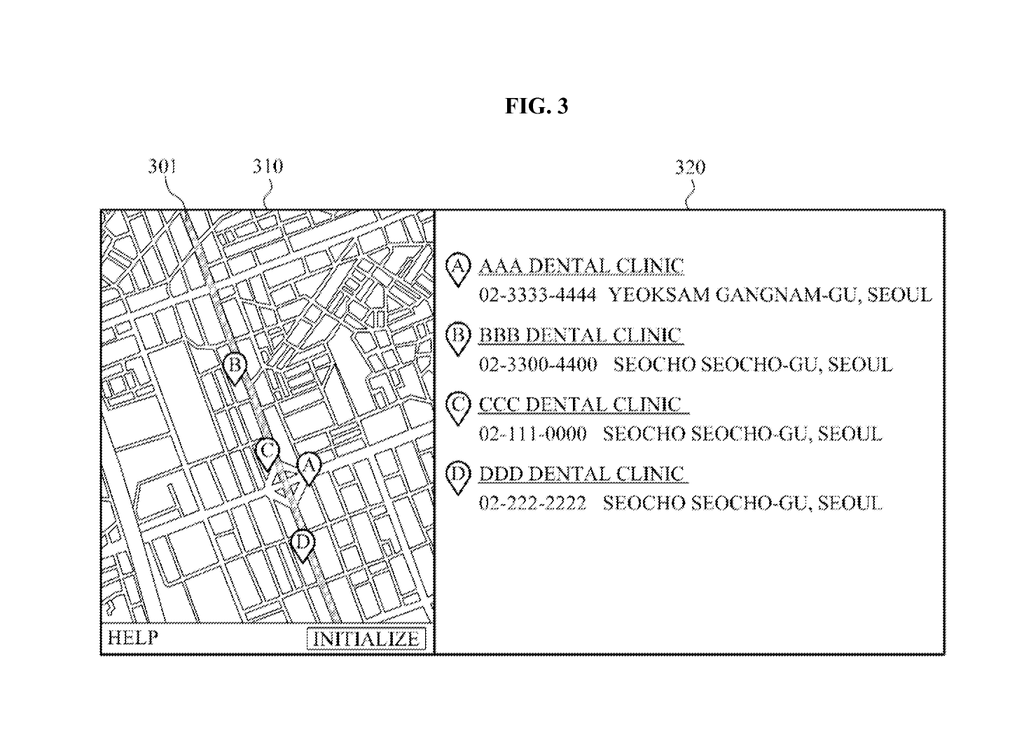

FIG. 3 is a view of a POI information providing service according to exemplary embodiments of the present invention. As shown in FIG. 3, the telematics system 120 may display a map screen 310 mapping a travel route 301 to a destination. The telematics system 120 may also display POI information 320 provided by the Internet telematics service providing system 110. The telematics system 120 may display a POI corresponding to the interest information to be distinguished from other POIs on the map screen 310, and may display the POI information 320 including a POI list and detail information for each POI, such as location information, a telephone number, and/or an address. For example, when interest information of the user corresponds to a “dental clinic”, POI information corresponding to dental clinics which may be situated along a travel route to the user's destination may be provided to the telematics system 120.

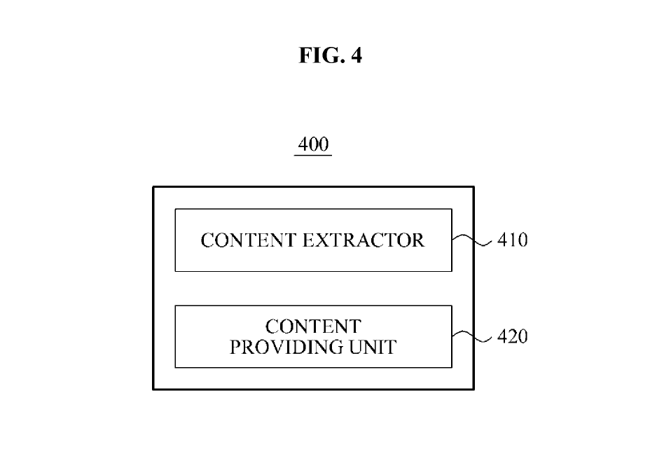

FIG. 4 is a block diagram illustrating an additional configuration of an Internet telematics service providing system 400 for providing content associated with a location of a vehicle and/or a travel route according to exemplary embodiments of the present invention. The Internet telematics service providing system 400 may correspond to the Internet telematics service providing system 110 and may further include a content extractor 410 and a content providing unit 420.

The content extractor 410 may automatically extract, from a social network service (SNS) server (not shown), content associated with a location of the user's vehicle and/or a travel route of the vehicle from a website associated with the user, based on the location of the vehicle and/or the travel route. For example, the content extractor 410 may extract content associated with the current location of the user and/or a travel route or content related to a corresponding area, from contents that are created by members of a website, online community, or social network joined by the user or online friends of the user.

The content providing unit 420 may provide the extracted content associated with the location of the vehicle and/or the travel route to the telematics system 120 in real time. For example, the telematics system 120 may display the content, provided from the content providing unit 420 based on the current location of the vehicle and/or the travel route, using a popup window. Content provided by the content providing unit 420 may include comments created after a member of a website, online community, or social network joined by the user (or an online friend of the user) visits a restaurant and when the current location of the vehicle is adjacent to the restaurant. The Internet telematics service providing system 400 may obtain the comments and provide the comments to the telematics system 120 so that the user may be informed of the comments through the telematics system 120.

According to the configuration of FIG. 4, the Internet telematics service providing system 400 may provide social information to the telematics system 110, in part, by providing content associated with the location of the vehicle and/or the travel route among contents of other users associated with the user.

As another example, using an Internet content providing server, the content extractor 410 may extract Internet content associated with at least one of POI extracted from interest information of the user, a POI selected by the user, a destination set in the telematics system 120, a POI en route to a destination of the vehicle, and/or an arrival place (e.g., current location) of the vehicle. The content extractor 410 may extract a detailed page, a coupon, an advertisement, and/or a picture associated with at least one POI of a selected POI, the set destination, the en route POI, and the arrival place. The content providing unit 420 may provide content associated with the at least one POI to the telematics system 120 and/or the communication terminal 130 of the user. The content associated with the at least one POI may be enlarged and displayed on a screen using the telematics system 120, or may be used in a place other than the vehicle using the telematics system 120.

As another example, using a SNS server, the content extractor 410 may extract, from a website associated with the user, content associated with POI information that is extracted based on interest information of the user. The content providing unit 420 may provide the extracted content to the telematics system 120 and/or the communication terminal 130 of the user. Also, the POI information providing unit 240 may provide the content extracted from the website associated with the user as interest information of the user and may thereby provide the extracted content as POI information.

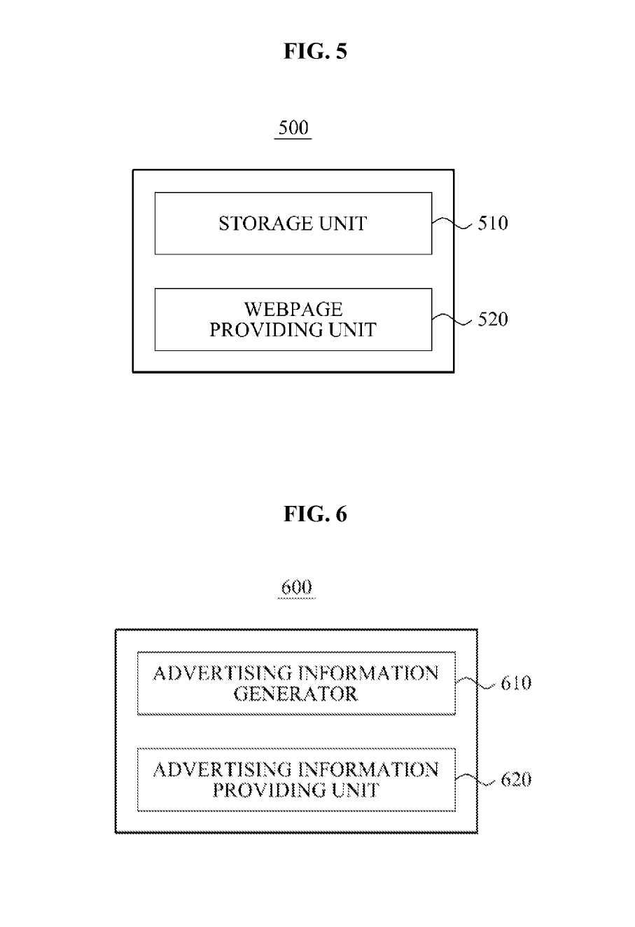

FIG. 5 is a block diagram illustrating an additional configuration of an Internet telematics service providing system 500 for providing and sharing content associated with POI information according to exemplary embodiments of the present invention. The Internet telematics service providing system 500 may correspond to the Internet telematics service providing system 400 of FIG. 4 and may further include a storage unit 510 and a webpage providing unit 520.

The storage unit 510 may store content associated with POI in a webpage associated with a user, a user database, a storage medium, and/or, in general, any suitable computer-readable media. The webpage associated with the user may indicate a page allocated to the user in a website corresponding to a Web community site, for example, a blog, a café, and/or a social network (e.g., me2TODAY).

Suitable computer-readable media may include, but are not limited to, transitory and non-transitory media, and volatile and non-volatile memory. The computer-readable media may include storage media, such as, for example, read-only memory (ROM), random access memory (RAM), floppy disk, hard disk, optical reading media (e.g., compact disc-read-only memory (CD-ROM), digital versatile discs (DVDs), hybrid magnetic optical disks, organic disks, flash memory drives or any other volatile or non-volatile memory, and other semiconductor media. The computer-readable storage media can store and execute computer-readable codes that are distributed in computers connected via a network. The computer-readable media also includes cooperating or interconnected computer-readable media that are in the processing system or are distributed among multiple processing systems that maybe local or remote to the processing system. The computer readable medium or media can be transportable, such that the program or programs stored thereon can be loaded onto one or more different computers or other processors to implement various aspects of the present invention as discussed herein.

The webpage providing unit 520 may provide the stored content to the telematics system 120 and/or the website associated with the user using an Internet/Web service. For example, the content stored in the webpage associated with the user may be shared by other users using the Web community site, for example, a blog, a café, and/or a social network (e.g., me2TODAY).

The Internet telematics service providing system 500 may automatically store, in the webpage associated with the user, content associated with a POI set by the user and may provide the stored content to other users so that the content may be shared with the other users without further action (e.g., a separate manipulation or storage) from the user.

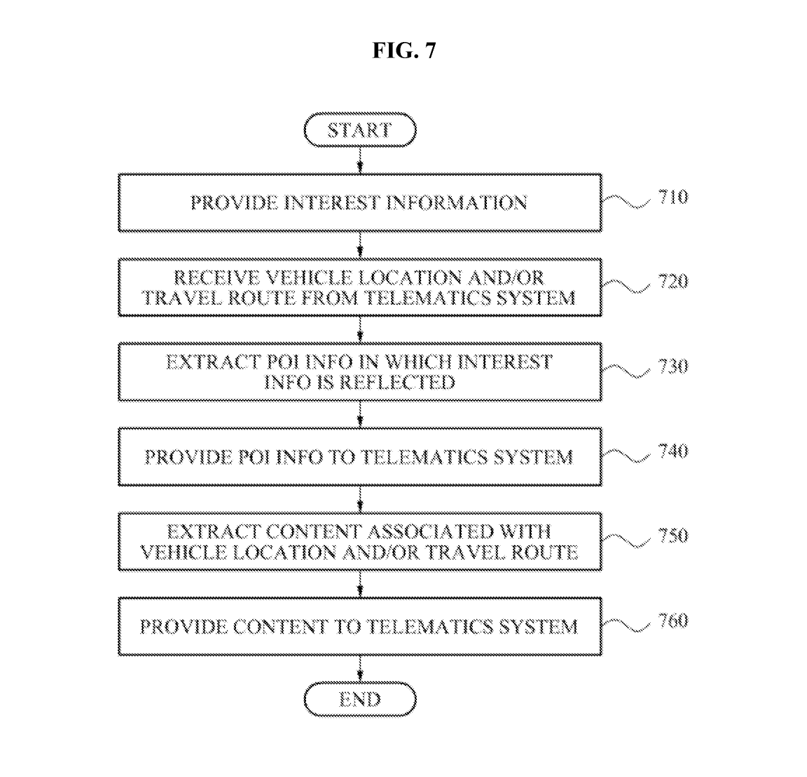

FIG. 6 is a block diagram illustrating an additional configuration of an Internet telematics service providing system 600 for providing advertising information associated with POI information according to exemplary embodiments of the present invention. The Internet telematics service providing system 600 may correspond to the Internet telematics service providing system 110 and may further include an advertising information generator 610 and an advertising information providing unit 620.

The advertising information generator 610 may generate advertising information associated with POI information by communicating with an advertising server (not shown). The advertising information generator 610 may generate advertising information about at least one of POI selected by the user through the telematics system 120, a destination of a vehicle set in the telematics system 120, a POI en route to a destination of the vehicle, and/or an arrival place (e.g., current location) of the vehicle. The advertising information may include information accessible to an advertisement and/or a homepage, which may be associated with at least one POI of the user-selected POI, the set destination, the en route POI, and the arrival place. For example, the advertising information generator 610 may determine a name of a POI as a keyword and may is then extract an advertisement corresponding to the keyword from the advertising server.

The advertising information providing unit 620 may provide the advertising information associated with the POI information to the telematics system 120 and/or the communication terminal 130 of the user. The advertising information providing unit 620 may immediately provide an advertisement associated with the POI information to the user using the telematics system 120 and/or the communication terminal 130.

The Internet telematics service providing system 600 may transfer the advertisement associated with the POI information to a predetermined device, for example, the telematics system 120 and/or the communication terminal 130, thereby providing the advertisement to the user. The predetermined device may be configured to receive the advertisement associated with the POI information according to configurations set by the user or a manufacturer of the Internet telematics service providing system 600.

FIG. 7 is a flowchart illustrating an Internet telematics service providing method for providing personalized and social information according to exemplary embodiments of the present invention. The Internet telematics service providing method may correspond to the Internet telematics service providing system described above with respect to FIG. 2 and FIG. 4.

In 710, the Internet telematics service providing system may provide interest information based on information available on the Internet and/or a telematics system 120 associated with a user. The Internet information associated with the user may include at least one of personal information of the user, for example, a hobby, an occupation age, and/or sex of the user. This information may be obtained from information input when the user joins a membership on the Internet, a search history of a search engine, a characteristic of a website bookmarked by the user, a characteristic of a website (e.g., a blog, café) associated with the user. The interest information of a user may also include interest information of an operator of the website associated with the user, interest information of another user selected by the user, and/or content created by the other user. The website associated with the user may be a website or an online community the user has joined. For example, the website associated with the user may include a blog, an online café, and/or a website (e.g., social networking website) in which the user may have online friends, acquaintances, and/or neighbors. Also, information provided by the telematics system 120 may include at least one telematics information among a POI list registered by the user or another user selected by the user, a search history of a POI, a visit history corresponding to a POI, and/or a current location of the user and/or the other user.

In 720, the Internet telematics service providing system may receive information regarding a location of the user's vehicle from the telematics system 120 in real time and may also receive information regarding a travel route to a destination set in the telematics system 120.

In 730, the Internet telematics service providing system may extract POI information corresponding to the interest information of the user based on the location of the vehicle and/or the travel route via an Internet map server. The Internet telematics service providing system may extract POIs located around the current location of the vehicle and/or the travel route of the vehicle, and may then extract POI information corresponding to the interest information from the extracted POIs. The Internet telematics service providing system may extract location information for each POI and detail information such as a telephone number and/or an address for each POI.

In 740, the Internet telematics service providing system may provide POI information corresponding to the interest information to the telematics system 120. POIs corresponding to the POI information may be displayed on a map screen mapping the current location of the vehicle and/or the travel route using the telematics system 120.

In 750, the Internet telematics service providing system may automatically extract content associated with a location of the vehicle and/or a travel route from a website associated with the user based on the location of the vehicle and/or the travel route, using a SNS server. For example, the Internet telematics service providing system may extract content associated with a current location of the user or a travel route of the user's vehicle, or content associated with a corresponding area, from contents that may be created by members of a website, online community, or social network joined by the user (e.g., online friends of the user).

In 760, the Internet telematics service providing system may provide the content associated with the location of the vehicle and/or the travel route to the telematics system 120 in real time. The telematics system 120 may display the content provided from the Internet telematics service providing system using a popup window.

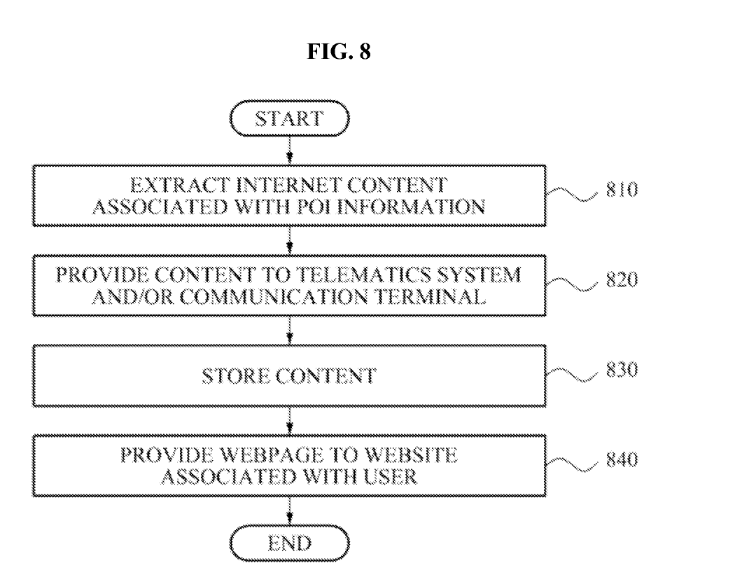

FIG. 8 is a flowchart illustrating an Internet telematics service providing method for providing and sharing content associated with POI information according to exemplary embodiments of the present invention. The Internet telematics service providing method may be performed by an Internet telematics service providing system described above with respect to FIG. 4 and FIG. 5.

In 810, the Internet telematics service providing system may extract content (e.g., Internet content) associated with POI information via an Internet content providing server. The Internet telematics service providing system may extract a detailed page, a coupon, an advertisement, and/or a picture, associated with at least one POI among POIs selected by the user through a telematics system 120, a destination of the vehicle set in the telematics system 120, a POI en route to a destination of the vehicle, and/or an arrival place (e.g., current location) of the vehicle. Also, using a SNS server, the Internet telematics service providing system may extract, from the website associated with the user, content associated with the extracted POI information based on interest information of the user.

In 820, the Internet telematics service providing system may provide content associated with the POI information to the telematics system 120 and/or a communication terminal 130 of the user. The content associated with POI information may be enlarged and displayed on a screen using the telematics system 120, or may be used in a place other than the vehicle using the telematics system 120.

In 830, the Internet telematics service providing system may store content associated with POI information in a webpage associated with a user, a user database, a storage medium, and/or, in general, any suitable computer-readable media. The webpage associated with the user may be a page allocated to the user in a website corresponding to a Web community site, for example, a blog, a café, and/or a social network (e.g., me2TODAY).

Suitable computer-readable media may include, but are not limited to, transitory and non-transitory media, and volatile and non-volatile memory. The computer-readable media may include storage media, such as, for example, read-only memory (ROM), random access memory (RAM), floppy disk, hard disk, optical reading media (e.g., compact disc-read-only memory (CD-ROM), digital versatile discs (DVDs), hybrid magnetic optical disks, organic disks, flash memory drives or any other volatile or non-volatile memory, and other semiconductor media. The computer-readable storage media can store and execute computer-readable codes that are distributed in computers connected via a network. The computer-readable media also includes cooperating or interconnected computer-readable media that are in the processing system or are distributed among multiple processing systems that maybe local or remote to the processing system. The computer readable medium or media can be transportable, such that the program or programs stored thereon can be loaded onto one or more different computers or other processors to implement various aspects of the present invention as discussed herein

In 840, the Internet telematics service providing system may provide the stored content to the telematics system 120 and/or the website associated with the user using an Internet/Web service. For example, the content stored in the webpage of the user may be shared with other users using a Web community site, for example, a blog, a café, and/or a social network (e.g., me2TODAY), which may be associated with the user.

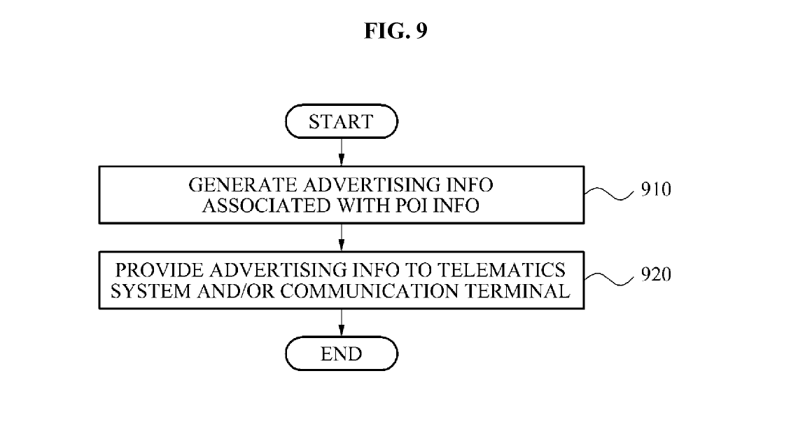

FIG. 9 is a flowchart illustrating an Internet telematics service providing method for providing advertising information associated with POI information according to exemplary embodiments of the present invention. The Internet telematics service providing method may be performed by an Internet telematics service providing system 600 described above with respect to FIG. 6.

In 910, the Internet telematics service providing system 600 may generate advertising information associated with POI information via an advertising server. The Internet telematics service providing system 600 may generate advertising information associated with at least one of a POI selected by the user through a telematics system 120, a destination of a vehicle set in the telematics system 120, a POI en route to a destination of the vehicle, and/or an arrival place (e.g., current location) of the vehicle.

In 920, the Internet telematics service providing system 600 may provide the advertising information associated with the POI information to the telematics system 120 and/or a communication terminal 130 of the user. The Internet telematics service providing system 600 may immediately provide an advertisement associated with at least one POI of the user-selected POI, the set destination, the en route POI, and the arrival place to the user using the telematics system 120 and/or the communication terminal 130.

According to exemplary embodiments of the present invention, it is possible to provide personalized and social Internet information to a user by providing POI information in which interest information of the user is reflected and by providing content of a website associated with the user as content associated with a location of a vehicle and/or a travel route. Also, content associated with a predetermined POI may be shared with other users through an Internet/Web service without requiring further action or storage by a user by automatically storing the content in a webpage associated with the user. An advertisement associated with the predetermined POI may be transferred to a predetermined device set by the user.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to provide a telematics service, the system comprising:
a telematics system;
an interest information provider to provide interest information based on information obtained from at least one of the Internet and the telematics system;
a route receiver to receive at least one of a location and a travel route from the telematics system;
a point of interest (POI) information extractor to extract POI information corresponding to the interest information based on the at least one of the location and the travel route; and
a POI information providing unit to provide the POI information to the telematics system.

2. The system of claim 1, further comprising:
a content extractor to extract content associated with the at least one of the location and the travel route from a website; and
a content providing unit to provide the content to the telematics system.

3. The system of claim 1, wherein the interest information provider provides the interest information based on at least one of personal information, a search history, a characteristic of a bookmarked website, a characteristic of a website associated with a user, interest information of an operator of the website associated with the user, interest information of another user selected by the user, and content created by the another user.

4. The system of claim 1, wherein the interest information provider provides the interest information based on at least one telematics information among a POI list registered in the telematics system, a search history corresponding to the POI information, and a visit history corresponding to the POI information.

5. The system of claim 1, further comprising:
a content extractor to extract content associated with at least one of a selected POI, a destination set in the telematics system, a POI en route to a destination, and an arrival place; and
a content providing unit to provide the content to at least one of the telematics system and a communication terminal.

6. The system of claim 5, further comprising:
a storage unit to store the content; and
a webpage providing unit to provide, via the Internet, the content to at least one of the telematics system and a website.

7. The system of claim 1, further comprising:
an advertising information generator to generate advertising information associated with the POI information; and
an advertising information providing unit to provide the advertising information to at least one of the telematics system and a communication terminal.

8. A method of providing a telematics service, the method comprising:
providing interest information based on information obtained from at least one of the Internet and a telematics system;
receiving at least one of a location and a travel route from the telematics system;
extracting point of interest (POI) information corresponding to the interest information based on the at least one of the location and the travel route; and
providing the POI information to the telematics system.

9. The method of claim 8, further comprising:
extracting content associated with the at least one of the location and the travel route from a website; and
providing the content to the telematics system.

10. The method of claim 8, wherein providing the interest information comprises providing the interest information based on at least one of personal information, a search history, a characteristic of a bookmarked website, a characteristic of a website associated with a user, interest information of an operator of the website associated with the user, interest information of another user selected by the user, and content created by the another user.

11. The method of claim 8, wherein the providing the interest information comprises providing the interest information based on at least one telematics information among a POI list registered in the telematics system, a search history corresponding to the POI information, and a visit history corresponding to the POI information.

12. The method of claim 8, further comprising:
extracting Internet content associated with at least one of a selected POI, a destination set in the telematics system, a POI en route to a destination, and an arrival place; and
providing the content to at least one of the telematics system and a communication terminal.

13. The method of claim 12, further comprising:
storing the content; and
providing, via the Internet, the content to at least one of the telematics system and a website.

14. The method of claim 8, further comprising:
generating advertising information associated with the POI information; and
providing the advertising information to at least one of the telematics system and a communication terminal.
